(19) United States
(12) Patent Application Publication
(10) Pub. No.: US 2012/0072202 A1
(43) Pub. Date: Mar. 22, 2012

(54) Sentence-based paragraphic online translating system and method thereof

(75) Inventors: Chaucer Chiu, Taipei (TW); Huchen Xu, Shanghai (CN)

(73) Assignee: INVENTEC CORPORATION, Taipei (TW)

(21) Appl. No.: 12/928,589

(22) Filed: Dec. 14, 2010

(30) Foreign Application Priority Data
Sep. 21, 2010 (TW) 099131994

(51) Int. Cl. G06F 17/28

(52) U.S. Cl. 704/2

(57) ABSTRACT

A sentence-based paragraphic online translating system and the method thereof are described. The paragraphic online translating system and the method thereof establish at least one sentence item in the database of a server, wherein each of the sentence items contains a first language article and a correspondingly translated second language article. When the server receives an inquiry sentence from a client, the paragraphic online translating system and the method thereof search for the sentence items within specific categories corresponding to the keywords extracted from the inquiry sentence, and then convert the inquiry sentence into a translated sentence according to the first language article and the second language article of the sentence items. Therefore, the paragraphic online translating system and the method thereof can achieve the effect of enhancing the fluency of online translation.

### BACKGROUND OF THE INVENTION

1. Field of Invention

The invention relates to an online translating system and the method thereof. In particular, the invention relates to a paragraphic online translating system that performs online translation for an inquiry sentence according to pre-stored first language articles and correspondingly translated second language articles. The method thereof is also disclosed.

2. Related Art

Thanks to advance in Internet technology and popularity of computers, people have more opportunities to encounter foreign languages. It has become indispensable to have online translating services for converting among different languages. Early online translating services use single words as the basic unit of translation. For example, suppose one wants to translate English to Chinese. When the server receives the original English word entered by the client, the server translates the English word into the corresponding Chinese word. If the user wants to translate a paragraph of an article or at least an entire sentence, the words obtained from single-word translation have to be combined according to appropriate grammatical rules. In order to help users who are not familiar with grammatical rules to translate, there appear online translating services that can perform paragraphic translation for inquiry sentences entered by clients.

Currently, the paragraphic online translating services on the market translate inquiry sentences according to grammatical rules. Since the computer uses a set of grammatical rules to recombine and translate an inquiry sentence, the actual translated sentence may convey an incorrect meaning or be verbose. This does not only cause a problem for the user to read, but may also mislead the user in understanding the meaning. Therefore, it is clear that the prior art has difficulty in providing fluent translations. It is thus imperative to provide a solution.

### SUMMARY OF THE INVENTION

In view of the foregoing, the invention discloses a sentence-based paragraphic online translating system and the method thereof.

The disclosed sentence-based paragraphic online translating system includes: a server, which includes a database pre-storing with at least one sentence item, wherein each of the sentence items contains a first language article, a correspondingly translated second language article, at least one keyword, and at least one category index; a receiving module for receiving an inquiry sentence; a comparison extracting module pre-established with an index list, wherein the index list contains at least one keyword and at least one category index corresponding to each of the keywords, the comparison extracting module extracts at least one keyword from the inquiry sentence according to the index list and obtains category indices corresponding to the extracted keywords, extracts the sentence item which corresponds to the category indices and contains the inquiry sentence in the first language article or the second language article, and converts the inquiry sentence into a translated sentence according to the first language article and the second language article of the sentence item; a transmitting module for transmitting the translated sentence to the client; and at least one client, each of which further includes a sentence extracting module for receiving the inquiry sentence entered by the client; a transmitting module for transmitting the inquiry sentence to the server; a receiving module for receiving the translated sentence; and a displaying module for displaying the translated sentence.

The disclosed sentence-based paragraphic online translating method includes the steps of: pre-establishing at least one sentence item in a database of a server, wherein each of the sentence items contains a first language article, a correspondingly translated second language article, at least one keyword, and at least one category index; pre-establishing an index list on the server, wherein the index list contains at least one keyword and at least one category index corresponding to each of the keywords; receiving an inquiry sentence from a client and sending the inquiry sentence to the server; extracting at least one keyword from the inquiry sentence according to the index list and obtaining category indices corresponding to the extracted keyword; extracting the sentence item which corresponds to the category indices and contains the inquiry sentence in the first language article or the second language article, and converting the inquiry sentence into a translated sentence according to the first language article and the second language article of the sentence item; transmitting the translated sentence from the server to the client; and receiving and displaying the translated sentence at the client.

The disclosed system and method as described above differ from the prior art in that the invention establishes at least one sentence item in the database of a server, wherein each of the sentence items contains a first language article and a correspondingly translated second language article. When the server receives an inquiry sentence from the client, it searches the sentence items within specific categories corresponding to the keywords extracted from the inquiry sentence. The inquiry sentence is converted into a translated sentence according to the first language article and the second language article in the sentence item. The invention can help enhance the fluency of online translation.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed sentence-based paragraphic online translating system;

FIG. 2 is a flowchart of the disclosed sentence-based paragraphic online translating method;

FIG. 3 is a schematic view of the storage format of the sentence items according to an embodiment of the invention; and

FIG. 4 is a schematic view of the index list according to an embodiment of the invention.

### DETAILED DESCRIPTION OF THE INVENTION

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

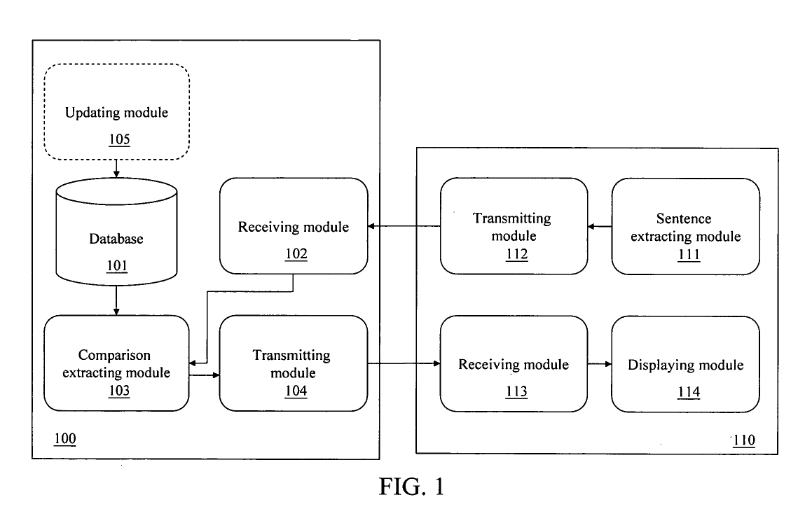

First, please refer to FIG. 1, which is a block diagram of the disclosed sentence-based paragraphic online translating system. It explains how the constituent modules of the system work. The sentence-based paragraphic online translating system is used in a server-client network environment. It includes a server 100 and at least one client 110. The server 100 includes a database 101, a receiving module 102, a comparison extracting module 103, and a transmitting module 104. The client 110 includes a sentence extracting module 111, a transmitting module 112, a receiving module 113, and a displaying module 114.

The database 101 on the server 100 pre-stores at least one sentence item. Each of the sentence items includes at least one category index, a first language article, a correspondingly translated second language article, and at least one keyword. For example, if the first language is English and the second language is Chinese, then each of the sentence items contains an English article, a correspondingly translated Chinese article, at least one keyword, and at least one category index corresponding to the sentence item. It should be noted that the keyword is a specific word or phrase in the first language article or the second language article. The category index is a possible classification of the sentence items. For example, suppose there is a sentence item storing English and corresponding Chinese articles explaining the structure of network. Then at least one keyword can be chosen from any specific terms in the articles, such as ‘channel’, ‘receiver’, ‘sender’, etc. Since these keywords are extracted from the English article, the corresponding phrases in the translated Chinese article also become keywords. Since the translation could be from English to Chinese or from Chinese to English, the keywords in the English article always have the corresponding keywords in the Chinese article. Therefore, the invention does not restrict the setting language of the keywords.

The comparison extracting module 103 first extracts keywords from the inquiry sentence and then searches articles in a specific field according to the category indices corresponding to the extracted keywords. The inquiry sentence is then translated into a translated sentence according to the English and Chinese articles. Therefore, in the above example of sentence items explaining the network structure, ‘channel’, ‘receiver’, ‘sender’, and so on are keywords. Then a possible category index is ‘network’, ‘communication’, ‘technology’, and so on. The difference between a keyword and a category index is that a keyword refers to the word or phrase extracted from an article, while a category index is used to distinguish different fields that an article belongs to. Through the category index, the system can search sentence items in different fields. Through the keyword, the system can search sentence items that contain the inquiry sentence in the English or Chinese article. This can greatly enhance the efficiency in searching the sentence items. To increase the fluency in translating sentences, the contents of the sentence items can be well-known articles both in the first language version and the second language version. They can be articles edited by specialists as well.

The receiving module 102 on the server 100 receives the inquiry sentence from the transmitting module 112 of the client 110. When the sentence extracting module 111 of the client 110 receives the inquiry sentence marked or entered by the user, the transmitting module 112 of the client 110 sends the inquiry sentence to the server 100 for online translation.

The comparison extracting module 103 of the server 100 pre-establishes an index list. The index list contains at least one keyword and at least one category index corresponding to the each of the keywords. Since each sentence item has many category indices, the keyword in the sentence item and the category indices may have a one-to-many relation. By searching the index list, the system can find the category indices corresponding to the keywords and then find the corresponding sentence item via the category indices. Therefore, when determining whether the first language article and the second language article contain the inquiry sentence, the system does not need to compare with all the sentence items in the database 101. It only needs to compare the relevant part of sentence items. This reduces the complexity in comparison.

After the receiving module of the server 100 receives the inquiry sentence, the comparison extracting module 103 first compares the inquiry sentence with the index list, thereby extracting at least one keyword and obtains the category indices corresponding to the extracted keywords. From the sentence item corresponding to the category index, the comparison extracting module 103 extracts the sentence item whose first language article or second language article contains the inquiry sentence. The inquiry sentence is then converted into a translated sentence according to the first language article and the second language article of the sentence item.

In addition, when the comparison extracting module 103 cannot find the sentence item whose first language article contains the inquiry sentence, it first finds possible words for substitution (eg. words that are close to the keyword in meaning) and performs a fuzzy comparison, thereby extracting the translated sentence.

After the comparison extracting module 103 of the server 100 produces the translated sentence, the translated sentence is transmitted by the transmitting module 104 of the server 100 to the client 110. After the client 110 receives the translated sentence, it is displayed by the displaying module 114.

It should be mentioned that when the transmitting module 104 of the server 100 transmits the translated sentence, the link address of the corresponding sentence item can be transmitted to the client 110 as well. After the link address is received by the receiving module 113 of the client 110, the received content is displayed by the displaying module 114. Take an example of translating English to Chinese. Suppose the client 110 transmits an English sentence in an English article. After the server 100 finds the corresponding English and Chinese articles that contain the submitted English sentence, the link address can be transmitted to the client 110 for the future viewing of the full articles of both language versions. With this, the client 110 can view the entire English and Chinese articles by clicking the link address, in addition to obtaining the translated sentence.

In addition to the above-mentioned module, the disclosed sentence-based paragraphic online translating system can further have an updating module 105 on the server 100 for adding or deleting the sentence items in the database 101. This can be used to ensure the data integrity of the sentence items in the database 101.

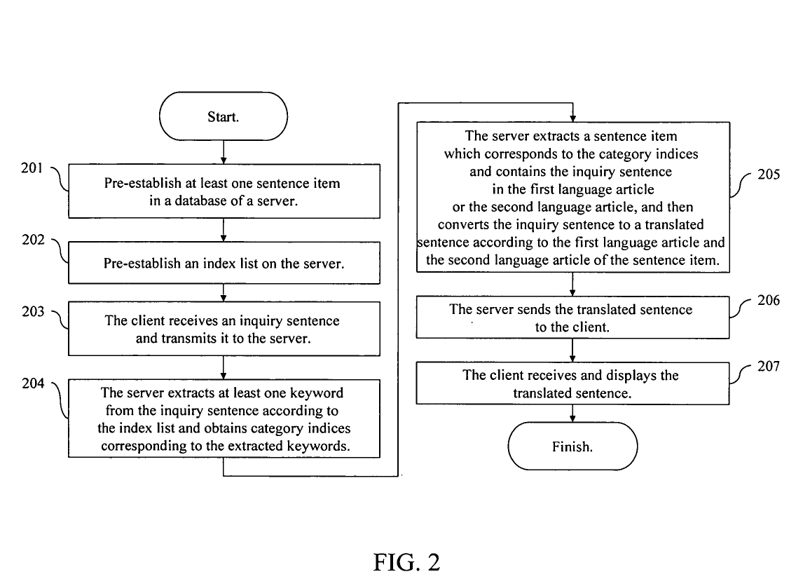

Please now refer to FIG. 2 for a flowchart of the disclosed sentence-based paragraphic online translating method.

The method first establishes at least one sentence item in a database of a server (step 201). Each of the sentence items includes at least a category index, a first language article, a correspondingly translated second language article, and at least one keyword. Suppose the first language is English and the second language is Chinese. In this case, each of the sentence items contains an English article, a correspondingly translated Chinese article, at least one keyword, and at least one category index corresponding to the sentence item. It should be noted that the keyword is a specific word or phrase in the first language article or the second language article. The category index is a possible classification of the sentence items. For example, suppose there is a sentence item explaining the structure of network in both Chinese and English versions. Then at least one keyword can be chosen from specific professional terms in the articles, such as ‘channel’, ‘receiver’, ‘sender’, etc. Since these keywords are extracted from the English article, the corresponding phrases in the translated Chinese article also become keywords. Since the translation could be from English to Chinese or from Chinese to English, the keywords in the English article always have the corresponding keywords in the Chinese article. Therefore, the invention does not restrict the setting language of the keywords.

The system first obtains the keywords from the inquiry sentence and then searches articles in a specific field according to the category indices corresponding to the keywords. The inquiry sentence is then translated into a translated sentence according to the English and Chinese articles. Therefore, in the above example of sentence items that store corresponding English and Chinese articles explaining the network structure, ‘channel’, ‘receiver’, ‘sender’, and so on are keywords. Then a possible category index is ‘network’, ‘communication’, ‘technology’, and so on. The difference between keywords and category index is that the keyword refers to the word or phrase extracted from an article, while the category index is used to distinguish different fields that an article belongs to. Through the category index, the system can search sentence items in different fields. Through the keyword, the system can search sentence items that contain the inquiry sentence in the English or Chinese article. This can greatly enhance the efficiency in searching the sentence items. To increase the fluency in translating sentences, the contents of the sentence items can be a well-know articles both in the first language and the second language version. They can be articles edited by specialists as well.

In addition to establishing the database, the method also has to establish an index list in advance (step 202). The index list stores at least one keyword and at least one category index corresponding to each of the keywords. Since each sentence item has many category indices, the keyword and the category indices may have a one-to-many relation. By searching the index list, the system can find the category indices corresponding to the keywords and then find the corresponding sentence item via the category indices. Therefore, when determining whether the first language article and the second language article contain the inquiry sentence, the system does not need to compare with all the sentence items in the database. It only needs to compare the relevant part of sentence items. This reduces the complexity in comparison.

Afterwards, the client receives the inquiry sentence and sends it to the server (step 203). The server extracts at least one keyword from the inquiry sentence according to the index list and obtains category indices corresponding to the extracted keywords (step 204). After finding the category index, the server extracts a sentence item which contains the inquiry sentence in the first language article or the second language article. The inquiry sentence is then converted into a translated sentence according to the first language article and the second language article of the sentence item (step 205). If no sentence item whose first language article contains the inquiry sentence can be found, possible words for substitution (eg. close to the keyword in meaning) is used for a fuzzy comparison, thereby extracting the translated sentence.

After the translated sentence is converted, the server transmits the translated sentence to the client (step 206). Finally, the client receives and displays the translated sentence (step 207). It should be mentioned that when the server transmits the translated sentence, the link address of the corresponding sentence item can be transmitted to the client as well. With this, the client can view the entire English and Chinese articles by clicking the link address, in addition to obtaining the translated sentence.

In the following, an online translating service using the invention is used as an embodiment to explain the process of translating from English to Chinese.

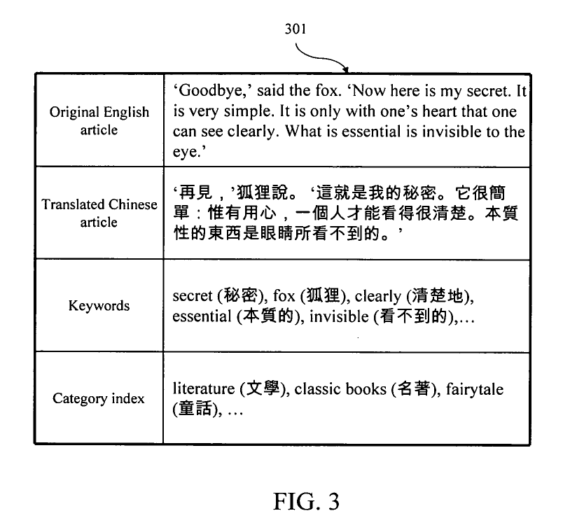

Before the service starts, the database has to have at least one sentence item. Suppose the stored sentence items are like table 301 shown in FIG. 3. Each sentence item has an English (as first language) article, a Chinese (as second language) article, at least one keyword, and the corresponding category indices. Each of said at least one keywords can be an English word extracted from the English article and/or an Chinese word extracted from the Chinese article. Also, each of said corresponding category indices can be both in English or Chinese since the category indices are only used to improve searching efficiency by searching articles in specific fields. To increase the fluency in translated sentences, the contents stored in the sentence items can be well-known articles both in the first language and the second language version. For example, a paragraph of the well-known novel “The Little Prince” in both English version and well-translated Chinese version, which are both shown in FIG. 3, can be used to be the contents stored in a sentence item. Additionally, the contents stored in the sentence items can be articles edited by specialists as well.

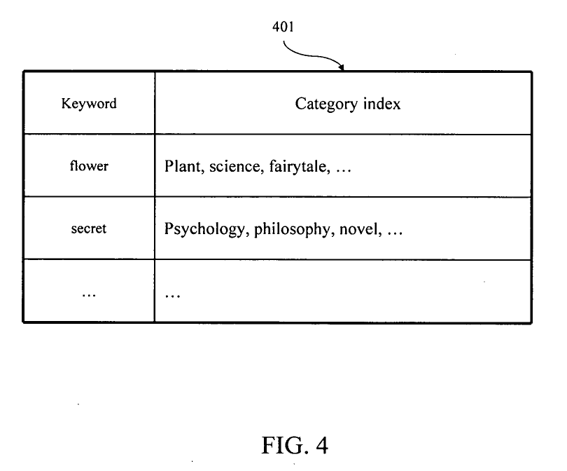

In addition to pre-establishing a database, an index list is also established. As shown in FIG. 4, each keyword corresponds to a distinct sentence item. The keywords and the category indices may have a one-to-many relation.

Suppose the user enters the inquiry sentence ‘What is essential is invisible to the eye.’ at the client. After receiving the inquiry sentence, the server extracts at least one keyword according to the index list. Assume that the keywords being extracted are ‘essential’, ‘invisible’, and ‘eye’. In this case, the server further finds category indices corresponding to the extracted keywords. Once the category indices are found, the server directly searches the sentence items under the category indices for a sentence item that contains the inquiry sentence ‘What is essential is invisible to the eye.’ in the first language articles or second language articles. If a sentence item is found, then the translated sentence corresponding to the inquiry sentence is extracted. In the current embodiment, the translated sentence ‘What is essential is invisible to the eye’ in Chinese is transmitted to the client for display. When the sentence item cannot be found, possible words for substitution is used for a fuzzy comparison, thereby extracting the translated sentence.

When the server transmits the translated sentence, the link address of the corresponding sentence item can be transmitted to the client as well. With this, the client can view the entire English and Chinese articles by clicking the link address, in addition to obtaining the translated sentence.

Besides, the sentence items in the database can be updated by adding and deleting. This increases the fluency in online translation.

In summary, the invention differs from the prior art in that the invention establishes at least one sentence item in a database of a server, wherein each of the sentence item contains a first language article and a correspondingly translated second language article. When the server receives an inquiry sentence from the client, it searches the sentence items within specific categories corresponding to the keywords extracted from the inquiry sentence. The inquiry sentence is converted into a translated sentence according to the first language article and the second language article in thee sentence item. The invention can help enhance the fluency of online translation.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A sentence-based paragraphic online translating system, comprising:
a server, including:
a database pre-storing at least one sentence item, wherein each of the sentence item contains at least one category index, a first language article, a correspondingly translated second language article, and at least one keyword;
a receiving module for receiving an inquiry sentence;
a comparison extracting module pre-established with an index list, wherein the index list contains at least one keyword and at least one category index corresponding to each of the keywords, the comparison extracting module extracts at least one keyword from the inquiry sentence according to the index list and obtains the category indices corresponding to the extracted keywords, extracts the sentence item which corresponds to the category indices and contains the inquiry sentence in the first language article or the second language article, and converts the inquiry sentence into a translated sentence according to the first language article and the second language article of the sentence item; and
a transmitting module for transmitting the translated sentence to the client; and
at least one client, each of which further includes:
a sentence extracting module for receiving the inquiry sentence entered by the client;
a transmitting module for transmitting the inquiry sentence to the server;
a receiving module for receiving the translated sentence; and
a displaying module for displaying the translated sentence.

2. The sentence-based paragraphic online translating system of claim 1, wherein when no sentence item that contains the inquiry sentence in the first language article is found, the comparison extracting module extracts a phrase close in meaning to the keyword for fuzzy comparison in order to extract the translated sentence from at least one sentence item.

3. The sentence-based paragraphic online translating system of claim 1, wherein the transmitting module of the server further transmits the link address of the sentence item to the client.

4. The sentence-based paragraphic online translating system of claim 3, wherein when the client selects the link address, the server transmits the link address of the sentence item, and after the client receives the sentence item, the first language article and the second language article of the sentence item is displayed by the displaying module.

5. The sentence-based paragraphic online translating system of claim 1, wherein the server further includes an updating module for adding or deleting sentence items in the database.

6. A sentence-based paragraphic online translating method, comprising the steps of:
pre-establishing at least one sentence item in a database of a server, wherein each of the sentence items contains a first language article, a correspondingly translated second language article, at least one keyword, and at least one category index;
pre-establishing an index list on the server, wherein the index list contains at least one keyword and at least one category index corresponding to each of the keywords;
receiving an inquiry sentence from a client and sending the inquiry sentence to the server;
extracting at least one keyword from the inquiry sentence according to the index list, and obtaining category indices corresponding to the extracted keywords;
extracting the sentence item which corresponds to the category indices and contains the inquiry sentence in the first language article or the second language article, and converting the inquiry sentence into a translated sentence according to the first language article and the second language article of the sentence item;
transmitting the translated sentence from the server to the client; and
receiving and displaying the translated sentence at the client.

7. The sentence-based paragraphic online translating method of claim 6 further comprising the step of extracting a phrase close in meaning to the keyword for fuzzy comparison in order to extract the translated sentence from at least one sentence item when no sentence item that contains the inquiry sentence in the first language article is found.

8. The sentence-based paragraphic online translating method of claim 6 further comprising the step of transmitting the link address of the sentence item to the client.

9. The sentence-based paragraphic online translating method of claim 8 further comprising the step of transmitting the link address of the sentence item from the server to the client when the client selects the link address the server, and displaying the first language article and the second language article of the sentence item at the client after the client receives the sentence item.

10. The sentence-based paragraphic online translating method of claim 6 further comprising the step of adding or deleting sentence items in the database.
